(19) United States
(12) Patent Application Publication
(10) Pub. No.: US 2026/0104163 A1
(43) Pub. Date: Apr. 16, 2026

(54) APPROACH TEMPERATURE STEAM GENERATOR CONTROL

(71) Applicant: NuScale Power, LLC, Corvallis, OR (US)

(72) Inventors: Benjamin R. Bristol, Philomath, OR (US); Adam Brigantic, Kennewick, WA (US)

(21) Appl. No.: 19/360,461

(22) Filed: Oct. 16, 2025

Related U.S. Application Data
(60) Provisional application No. 63/708,144, filed on Oct. 16, 2024.

(51) Int. Cl. F22B 35/00; F22B 1/02; G21D 1/00

(52) U.S. Cl. CPC F22B 35/004; F22B 1/023; G21D 1/006

(57) ABSTRACT

A flow control system comprising a steam generator (SG) having an inlet and an outlet, the SG including a plurality of SG tubes extending from the inlet to the outlet, a primary coolant system configured to transfer heat to the SG, a steam valve fluidly connected to the outlet of the SG, and an SG level control system configured to operate the steam valve based at least in part on an approach temperature.

### CROSS-REFERENCE TO RELATED APPLICATIONS

This application claims priority to U.S. Provisional Patent Application No. 63/708,144, filed Oct. 16, 2024, and titled “Approach Temperature Steam Generator Control,” which is incorporated herein by reference in its entirety.

### STATEMENT REGARDING FEDERALLY SPONSORED RESEARCH

This invention was made with Government support under contract No. DE-NE0008928 awarded by the Department of Energy. The Government has certain rights in this invention.

### BACKGROUND

Density Wave Oscillation (DWO) is a type of flow instability wherein density changes in a two-phase liquid flowing within a channel causes oscillating flow and pressure within the channel. Over time excessive DWO events may lead to damage. In order to minimize, reduce, or eliminate DWO events, methods and systems to identify, prevent, and/or stop DWO events are necessary.

### BRIEF DESCRIPTION OF THE DRAWINGS

FIG. 1 is a partially schematic, partially cross-sectional view of a nuclear reactor system configured in accordance with embodiments of the present technology, according to an embodiment of this disclosure.

FIG. 2 is a partial schematic, partial cross-sectional view of a nuclear reactor system configured in accordance with additional embodiments of the present technology, according to an embodiment of this disclosure.

FIG. 3 is a schematic view of a nuclear power plant system including multiple nuclear reactors in accordance with embodiments of the present technology, according to an embodiment of this disclosure.

FIG. 4 is a graph illustrating Steam Generator (SG) tube vapor phase region pressure drop compared to total SG tube pressure drop, according to an embodiment of this disclosure.

FIG. 5 illustrates a diagram of a helically coiled SG, according to an embodiment of this disclosure.

FIG. 6 is a graph illustrating the ratio of vapor pressure drop and SG tube pressure drop as a function of tube flow (e.g., SG Power (%)), according to an embodiment of this disclosure.

FIG. 7 illustrates a graph illustrating an SG nominal temperature profile and an SG DWO temperature profile, according to an embodiment of this disclosure.

FIG. 8 is a graph illustrating SG tube vapor region temperature profiles for Reactor Coolant System (RCS) flow and SG flow, according to an embodiment of this disclosure.

FIG. 9 is a graph illustrating approach temperature during a DWO flow ramp test, according to an embodiment of this disclosure.

FIG. 10 is a graph illustrating approach temperature code to data comparison, according to an embodiment of this disclosure.

FIG. 11 is a graph illustrating flowrate decrease results for vapor differential pressure (dPR) and approach temperature compared to dryout location, according to an embodiment of this disclosure.

FIG. 12 is a graph illustrating approach temperature at DWO onset as a function of SG power, according to an embodiment of this disclosure.

FIG. 13 is a graph illustrating the operation zones relative to DWO events as a function of approach temperature and SG power, according to an embodiment of this disclosure.

FIG. 14 illustrates an exemplary process to control flow within a SG tube, according to an embodiment of this disclosure.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

This disclosure is directed to systems and methods for detecting the onset of Density Wave Oscillation (DWO) in advanced nuclear reactors (e.g., small modular nuclear reactors (SMRs)) and for initiating system responses to preclude and/or terminate DWO events. Specifically, the disclosure is directed to the detection of and responses to DWO events within steam generator (SG) tubes.

Ideally, liquid flows into an SG tube at the same rate that steam flows out of the SG tube, and the flow is constant and steady. DWO is a type of flow oscillation in a two-phase flow system caused by fluid density changes throughout the system that cause differences (e.g., fluctuations, oscillations, etc.) in the flowrate throughout the system. These fluctuations subsequently cause changes in heat transfer from the heat source to the fluid, which leads to temperature changes of the SG tube itself. Accordingly, temperature changes within the SG tube cause expansion and/or retraction of the SG tube. Over time, repeated expansion and/or contraction of the SG tube may cause damage to the SG tube and reduce efficiency of the SG.

As fluid travels through the SG tube, the liquid absorbs adequate heat to create a boiling region where the liquid transitions to steam. As the phase of the fluid changes, the local density of the fluid is reduced. This localized density reduction causes a pressure drop in the localized area. The newly formed low-pressure area in the localized area causes an increase to the flowrate of the liquid flowing into the SG tube. The increased liquid flow pushes the boiling region downstream (i.e., increases the volume of steam within the SG tube). As the liquid pushes the boiling region downstream, the liquid absorbs adequate heat to create a new boiling region, and the cycle repeats.

In order to preclude the onset of a DWO event in a SG tube, a number of real-time parameters must be detected and adjusted (e.g., liquid inlet flowrate, liquid inlet temperature, liquid level within the SG tube, steam temperature within the SG tube, steam temperature exiting the SG tube, steam outlet flowrate, etc.). Collection of these parameters is not practical since an SG may have hundreds or thousands of SG tubes and installation of hundreds or thousands of sensors would cause several problems, including excessive costs, generation of significant amounts of radioactive material, and reduced efficiency of flow through each SG tube.

In an embodiment, precluding a DWO event may include detecting the inlet flow for an SG tube, detecting the outlet flow for the SG tube, and making adjustments as required to maintain a threshold difference between the inlet flow and the outlet flow of the SG tube. However, economic and design constraints render direct measurement of inlet and outlet flowrates for each SG tube unpracticable. Based on experimentation and study of DWO events, a correlation may be made between the flowrate of fluid through the SG tube and the level of the liquid fluid within the SG tube. However, the same economic and design constraints that render direct measurement of inlet and outlet flowrates for each SG tube unpracticable, render direct measurement of inlet and outlet flowrates for each SG tube unpracticable.

After additional experimentation and study of DWO events, a correlation may be made between the temperature difference of the fluid through the SG tube (i.e., the difference between the temperature of the liquid entering the SG tube and the temperature of the steam exiting the SG tube) and the level of the liquid fluid within the SG tube.

Based on experimentation and study into the onset of DWO events within Nuclear Power Modules (NPMs), the systems and methods disclosed herein describe how DWO driven flow instabilities (e.g., DWO events) can be avoided in NPM SG operations without generating excessive costs, generating significant amounts of radioactive material, and without reducing the efficiency of flow through each SG tube. More specifically, the systems and methods disclosed herein may describe how DWO events may be precluded by detecting readily available parameters (e.g., peak primary system temperature, SG liquid inlet temperature, and SG steam outlet temperature), determining fluid levels within the SG tubes based at least in part on readily available parameters, determining flowrate through the SG tubes based at least in part on the determined fluid levels, and adjusting fluid flow through the SG based on the determined flowrate through the SG tubes.

DWO onset may be correlated to the difference of the primary temperature and the SG saturation temperature (i.e., the temperature of the steam exiting the SG relative to the temperature of the primary system) as a function of secondary flowrate for a given tube inlet flow restrictor design and SG tube design (length, diameter, tube thickness). In an embodiment, the difference between the primary system temperature and the temperature of the steam exiting the SG may be the Approach Temperature. In an embodiment, a high (e.g., large, etc.) Approach Temperature demonstrates a large temperature difference between the primary system temperature and the temperature of the steam exiting the SG. Likewise, a low (e.g., small, etc.) Approach Temperature demonstrates a small temperature difference between the primary system temperature and the temperature of the steam exiting the SG.

In an embodiment, DWO events may occur when the liquid level in the SG tube is lower relative to the steam level within the SG tube. For example, since the SG tube is full of fluid, if there is less liquid within the tube, there must be more steam. Following the example, a greater area full of steam allows for more heat transfer from the primary coolant circulating outside the SG tube into the steam within the SG tube, which results in the steam having a relatively higher temperature than steam generated within the tube having less opportunity for heat transfer (i.e., an SG tube having more steam within it produces steam at a higher temperature than an SG tube having less steam within it). The higher the steam temperature exiting the SG tube, the lower the temperature difference between the steam and the primary coolant temperature, therefore the lower the approach temperature. Accordingly, as the approach temperature decreases, the probability for a DWO increases.

During typical SG operation, liquid flows through a plurality of SG tubes, the liquid is converted into steam, and the steam exits the SG tube as steam. As the SG operates to generate steam, each SG tube of the plurality of SG tubes may include at least three regions (e.g., zones, sections, portions, etc.). For example, the first region may be full of liquid (e.g., sub-cooled liquid region), the second region may be full of a combination of liquid and gas (e.g., two-phase region), and the third region may be full of steam (e.g., steam region). During typical SG operation, the size of each region may vary. For example, at a first time of operation, the first region may extend throughout the SG tube having a first volume, and at a second time that is after the first time, the first region may extend through the SG tube having a second volume that is greater than the first volume. Similarly, the third region may extend throughout the SG tube having a third volume at the first time and extend throughout the SG tube having a fourth volume that is less than the third volume at the second time. In an embodiment, the length of the SG tube does not change, therefore whenever the volume of a region increases, the volume of at least one of the other regions must decrease.

In an embodiment, the entire length of the SG tube is filled with a fluid, and the entire length of the SG tube is exposed to a heat source (e.g., primary system coolant, etc.), which causes heat to transfer from the heat source into the fluid throughout the entire length of the SG tube, including all three regions. This transfer of heat throughout the SG tube results in the inlet temperature of the liquid entering the first region being lower than the temperature of the steam exiting the third region of the SG tube. The larger a region may be, the more heat may be received by the fluid within that region, which may in turn increase the temperature of the fluid exiting the region.

For example, in an SG tube with a third region having a first volume, the steam within the third region will continue to absorb heat while the steam travels through the remaining portion of the SG tube, thus the steam exiting the third region having a first volume will have a first temperature. If the third region of the SG tube had a second volume that was larger than the first volume, the steam traveling through the third region having a second volume will absorb more heat, thus the steam exiting the third region having a second distance will have a second temperature that is higher than the first temperature.

In an embodiment, the temperature of the steam exiting the SG tube may be detected and the approach temperature may be determined by comparing the difference between the temperature of the steam exiting the SG tube and the peak primary coolant system temperature. The approach temperature may be used to determine the volume of steam within the SG tube. The volume of steam within the SG tube may be used to determine the level of the liquid within the SG tube. The level of the liquid within the SG tube may be used to determine the flowrate into the SG tube.

In an embodiment, flow through the SG tube may be adjusted based at least in part on the approach temperature. In an embodiment, the steam exiting the SG tube may be directed to a steam turbine. The flowrate of the steam supply to the steam turbine may be adjusted via a throttle valve. In an embodiment, manipulation of a throttle valve (e.g., opening, closing, throttling, etc.) to regulate the flowrate of steam exiting the SG tubes may adjust (e.g., increase, decrease, and/or maintain) the pressure of the fluid within the SG tube. For example, the throttle valve may be shut to reduce flow to the steam turbine, which will increase the pressure within the SG tube. The increased pressure within the SG tube may cause the level of the liquid within the SG tube to rise, which will decrease the volume of steam within the SG tube. The decreased volume of steam within the SG tube reduces the amount of heat the steam is able to absorb from the primary coolant before the steam exits the SG tube. By absorbing less heat from the primary coolant, the steam will exit the SG tube at a lower temperature than before the throttle valve was closed. The new reduced temperature of the steam exiting the SG tube may be compared to the primary coolant temperature to determine a new approach temperature. With the temperature of the steam lowering and the primary coolant temperature being unchanged, the temperature difference between the steam and the primary system increases, thus the new approach temperature increases. The increased approach temperature is indicative of conditions that are less likely to result in DWO events.

In an embodiment, the level of the liquid within the SG tube may be determined and controlled to establish and maintain conditions associated with avoiding DWO events. For example, DWO events are more likely to occur in SG tubes having low liquid levels. Accordingly, the determination of the approach temperature may provide a means to calculate and determine the liquid level within an SG tube when detecting actual values are not practicable.

In an embodiment, DWO events may cause excessive stress (e.g., thermal fatigue, stress fractures, deformation, etc.) to one or more components within the SG, depending on the construction and design. For example, DWO events may cause flow-induced vibration within one or more SG tubes affected and/or allow for impingement due to water hammer. In an embodiment, DWO events may lead to damage to SG tubes, tubesheet welds, SG tube support structures, or any other component subjected to the thermal changes and/or vibrations caused by the DWO events.

In an embodiment, historical operation data for a SG (e.g., temperature, flowrates, approach temperatures, etc.) may be analyzed to determine expected wear of those components susceptible to damage caused by DWO events (e.g., SG tubes, SG tubesheet(s), etc.). The expected wear may be compared to the results of actual component inspections (e.g., visual, ultrasonic, etc.). In an embodiment, the differences between the expected wear and actual wear may be used to determine an operational threshold that may be useful for determining operational limits, maintenance efficacy, or other performance and longevity-based parameter.

### Illustrative Embodiments

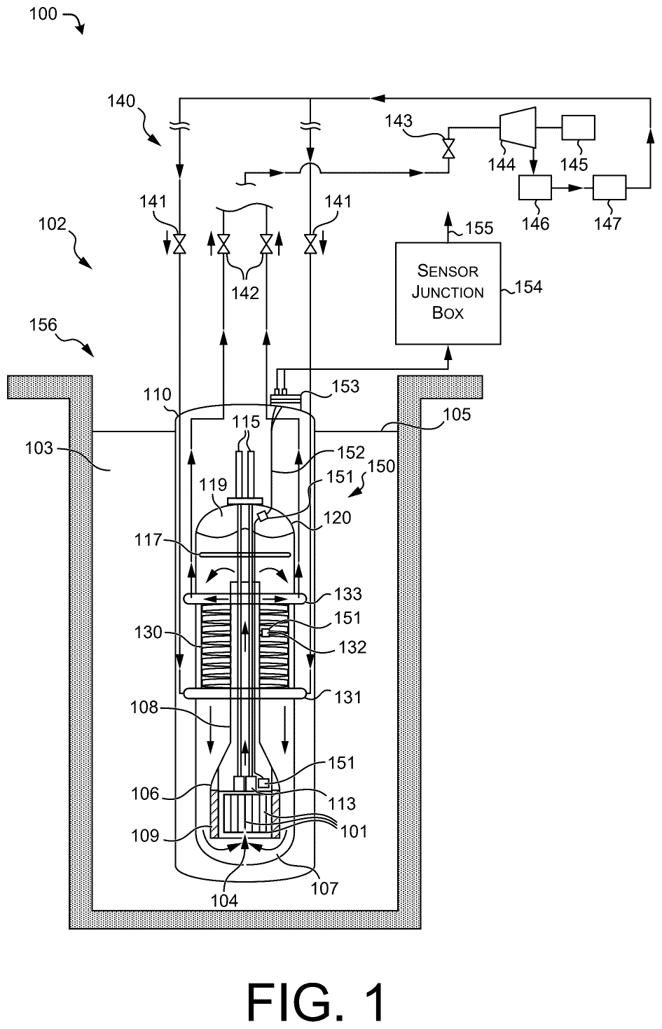

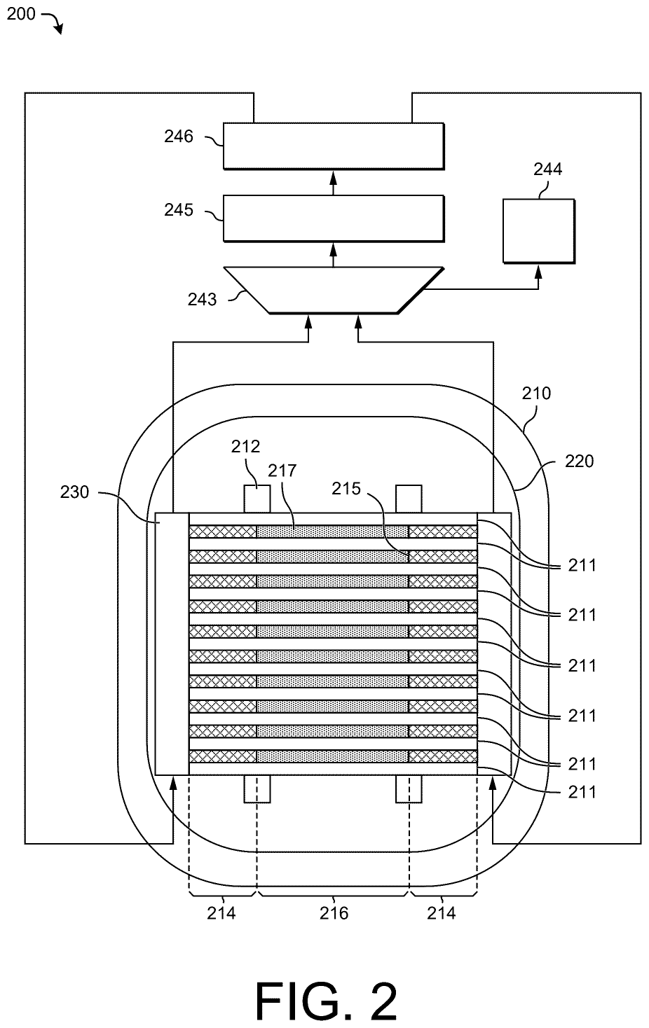

FIGS. 1 and 2 illustrate representative nuclear reactors that may be included in embodiments of the present technology. FIG. 1 is a partially schematic, partially cross-sectional view of a nuclear reactor system 100 configured in accordance with embodiments of the present technology. The system 100 can include a power module 102 having a reactor core 104 in which a controlled nuclear reaction takes place. Accordingly, the reactor core 104 can include one or more fuel assemblies 101. The fuel assemblies 101 can include fissile and/or other suitable materials. Heat from the reaction generates steam at a steam generator 130, which directs the steam to a power conversion system 140. The power conversion system 140 generates electrical power, and/or provides other useful outputs, such as super-heated steam. A sensor system 150 is used to monitor the operation of the power module 102 and/or other system components. The data obtained from the sensor system 150 can be used in real time to control the power module 102, and/or can be used to update the design of the power module 102 and/or other system components.

The power module 102 includes a containment vessel 110 (e.g., a radiation shield vessel, or a radiation shield container) that houses/encloses a reactor vessel 120 (e.g., a reactor pressure vessel, or a reactor pressure container), which in turn houses the reactor core 104. The containment vessel 110 can be housed in a power module bay 156. The power module bay 156 can contain a cooling pool 103 filled with water and/or another suitable cooling liquid. The bulk of the power module 102 can be positioned below a surface 105 of the cooling pool 103. Accordingly, the cooling pool 103 can operate as a thermal sink, for example, in the event of a system malfunction.

A volume between the reactor vessel 120 and the containment vessel 110 can be partially or completely evacuated to reduce heat transfer from the reactor vessel 120 to the surrounding environment (e.g., to the cooling pool 103). However, in other embodiments the volume between the reactor vessel 120 and the containment vessel 110 can be at least partially filled with a gas and/or a liquid that increases heat transfer between the reactor vessel 120 and the containment vessel 110. For example, the volume between the reactor vessel 120 and the containment vessel 110 can be at least partially filled (e.g., flooded with the primary coolant 107) during an emergency operation.

Within the reactor vessel 120, a primary coolant 107 conveys heat from the reactor core 104 to the steam generator 130. For example, as illustrated by arrows located within the reactor vessel 120, the primary coolant 107 is heated at the reactor core 104 toward the bottom of the reactor vessel 120. The heated primary coolant 107 (e.g., water with or without additives) rises from the reactor core 104 through a core shroud 106 and to a riser tube 108. The hot, buoyant primary coolant 107 continues to rise through the riser tube 108, then exits the riser tube 108 and passes downwardly through the steam generator 130. The steam generator 130 includes a multitude of conduits 132 that are arranged circumferentially around the riser tube 108, for example, in a helical pattern, as is shown schematically in FIG. 1. The descending primary coolant 107 transfers heat to a secondary coolant (e.g., water) within the conduits 132, and descends to the bottom of the reactor vessel 120 where the cycle begins again. The cycle can be driven by the changes in the buoyancy of the primary coolant 107, thus reducing or eliminating the need for pumps to move the primary coolant 107.

The steam generator 130 can include a feedwater header 131 at which the incoming secondary coolant enters the steam generator conduits 132. The secondary coolant rises through the conduits 132, converts to vapor (e.g., steam), and is collected at a steam header 133. The steam exits the steam header 133 and is directed to the power conversion system 140.

The power conversion system 140 can include one or more steam valves 142 that regulate the passage of high pressure, high temperature steam from the steam generator 130 to a steam turbine 144. In an embodiment, the power conversion system may include a steam throttle valve 143 (e.g., steam flow control valve, backpressure valve, backpressure controller, etc.). The steam throttle valve 143 may include a globe valve, gate valve, poppet valve, or any other reasonable valve. In an embodiment, the steam throttle valve 143 may be manually actuated, electrically actuated, mechanically actuated, or actuated via any other local or remote method (e.g., solenoid valve, pneumatic valve, manual valve, etc.). The steam turbine 144 converts the thermal energy of the steam to electricity via a generator 145. The low-pressure steam exiting the turbine 144 is condensed at a condenser 146, and then directed (e.g., via a pump 147) to one or more feedwater valves 141. The feedwater valves 141 control the rate at which the feedwater re-enters the steam generator 130 via the feedwater header 131. In other embodiments, the steam from the steam generator 130 can be routed for direct use in an industrial process, such as a Hydrogen (H₂) and Oxygen (O₂) production plant, a chemical production plant, and/or the like, as described in detail below. Accordingly, steam exiting the steam generator 130 can bypass the power conversion system 140.

The power module 102 includes multiple control systems and associated sensors. For example, the power module 102 can include a hollow cylindrical reflector 109 that directs neutrons back into the reactor core 104 to further the nuclear reaction taking place therein. Control rods 113 are used to modulate the nuclear reaction and are driven via fuel rod drivers 115. The pressure within the reactor vessel 120 can be controlled via a pressurizer plate 117 (which can also serve to direct the primary coolant 107 downwardly through the steam generator 130) by controlling the pressure in a pressurizing volume 119 positioned above the pressurizer plate 117.

The sensor system 150 can include one or more sensors 151 positioned at a variety of locations within the power module 102 and/or elsewhere, for example, to identify operating parameter values and/or changes in parameter values. The data collected by the sensor system 150 can then be used to control the operation of the system 100, and/or to generate design changes for the system 100. For sensors positioned within the containment vessel 110, a sensor link 152 directs data from the sensors to a flange 153 (at which the sensor link 152 exits the containment vessel 110) and directs data to a sensor junction box 154. From there, the sensor data can be routed to one or more controllers and/or other data systems via a data bus 155.

FIG. 2 is a partially schematic, partially cross-sectional view of a nuclear reactor system 200 configured in accordance with additional embodiments of the present technology. In some embodiments, the nuclear reactor system 200 (“system 200”) can include some features that are at least generally similar in structure and function, or identical in structure and function, to the corresponding features of the system 100 described in detail above with reference to FIG. 1 and can operate in a generally similar or identical manner to the system 100.

In the illustrated embodiment, the system 200 includes a reactor vessel 220 and a containment vessel 210 surrounding/enclosing the reactor vessel 220. In some embodiments, the reactor vessel 220 and the containment vessel 210 can be roughly cylinder-shaped or capsule shaped. The system 200 further includes a plurality of heat pipe layers 211 within the reactor vessel 220. In the illustrated embodiment, the heat pipe layers 211 are spaced apart from and stacked over one another. In some embodiments, the heat pipe layers 211 can be mounted/secured to a common frame 212, a portion of the reactor vessel 220 (e.g., a wall thereof), and/or other suitable structures within the reactor vessel 220. In other embodiments, the heat pipe layers 211 can be directly stacked on top of one another such that each of the heat pipe layers 211 supports and/or is supported by one or more of the other ones of the heat pipe layers 211.

In the illustrated embodiment, the system 200 further includes a shield or reflector region 214 at least partially surrounding a core region 216. The heat pipe layers 211 can be circular, rectilinear, polygonal, and/or can have other shapes, such that the core region 216 has a corresponding three-dimensional shape (e.g., cylindrical, spherical). In some embodiments, the core region 216 is separated from the reflector region 214 by a core barrier 215, such as a metal wall. The core region 216 can include one or more fuel sources, such as fissile material, for heating the heat pipe layers 211. The reflector region 214 can include one or more materials configured to contain/reflect products generated by burning the fuel in the core region 216 during operation of the system 200. For example, the reflector region 214 can include a liquid or solid material configured to reflect neutrons and/or other fission products radially inward toward the core region 216. In some embodiments, the reflector region 214 can entirely surround the core region 216. In other embodiments, the reflector region 214 may partially surround the core region 216. In some embodiments, the core region 216 can include a control material 217, such as a moderator and/or coolant. The control material 217 can at least partially surround the heat pipe layers 211 in the core region 216 and can transfer heat therebetween.

In the illustrated embodiment, the system 200 further includes at least one heat exchanger 230 (e.g., a steam generator) positioned around the heat pipe layers 211. The heat pipe layers 211 can extend from the core region 216 and at least partially into the reflector region 214 and are thermally coupled to the heat exchanger 230. In some embodiments, the heat exchanger 230 can be positioned outside of or partially within the reflector region 214. The heat pipe layers 211 provide a heat transfer path from the core region 216 to the heat exchanger 230. For example, the heat pipe layers 211 can each include an array of heat pipes that provide a heat transfer path from the core region 216 to the heat exchanger 230. When the system 200 operates, the fuel in the core region 216 can heat and vaporize a fluid within the heat pipes in the heat pipe layers 211, and the fluid can carry the heat to the heat exchanger 230. The heat pipes in the heat pipe layers 211 can then return the fluid toward the core region 216 via wicking, gravity, and/or other means to be heated and vaporized once again.

In some embodiments, the heat exchanger 230 can be similar to the steam generator 130 of FIG. 1 and, for example, can include one or more helically-coiled tubes that wrap around the heat pipe layers 211. The tubes of the heat exchanger 230 can include or carry a working fluid (e.g., a coolant such as water or another fluid) that carries the heat from the heat pipe layers 211 out of the reactor vessel 220 and the containment vessel 210 for use in generating electricity, steam, and/or the like. For example, in the illustrated embodiment the heat exchanger 230 is operably coupled to a turbine 243, a generator 244, a condenser 245, and a pump 246. As the working fluid within the heat exchanger 230 increases in temperature, the working fluid may begin to boil and vaporize. The vaporized working fluid (e.g., steam) may be used to drive the turbine 243 to convert the thermal potential energy of the working fluid into electrical energy via the generator 244. The condenser 245 can condense the working fluid after it passes through the turbine 243, and the pump 246 can direct the working fluid back to the heat exchanger 230 where it can begin another thermal cycle. In other embodiments, steam from the heat exchanger 230 can be routed for direct use in an industrial process, such as an enhanced oil recovery operation described in detail below. Accordingly, steam exiting the heat exchanger 230 can bypass the turbine 243, the generator 244, the condenser 245, the pump 246, etc.

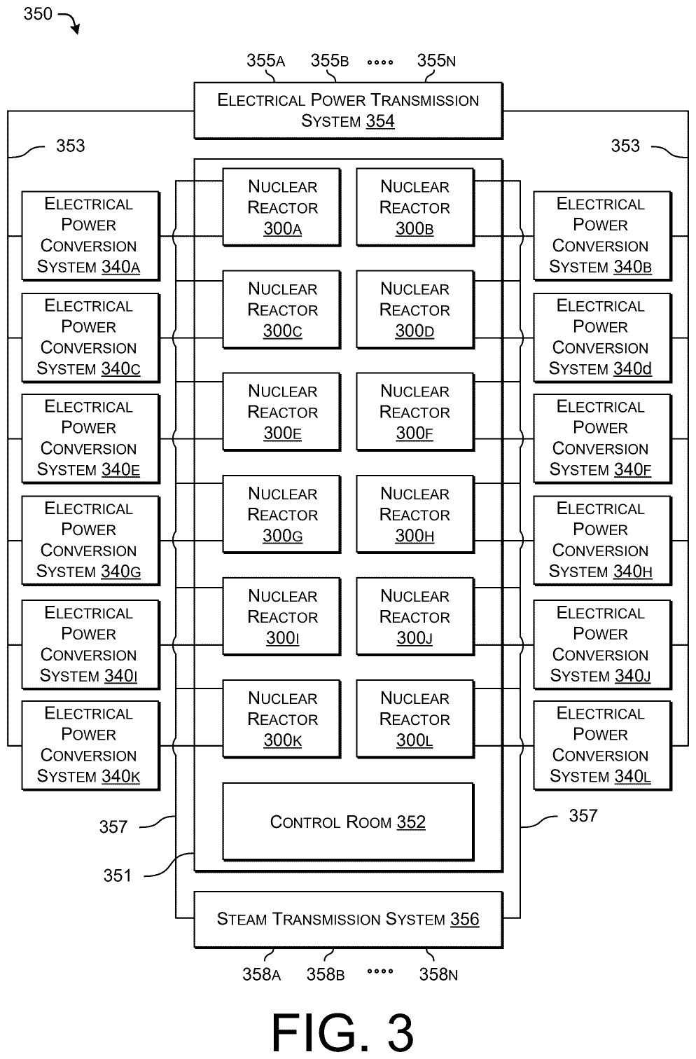

FIG. 3 is a schematic view of a nuclear power plant system 350 including multiple nuclear reactors 300 in accordance with embodiments of the present technology. Each of the nuclear reactors 300 (individually identified as first through twelfth nuclear reactors 300a-1, respectively) can be similar to or identical to the nuclear reactor 300 and/or the nuclear reactor 300 described in detail above with reference to FIGS. 1 and 2. The power plant system 350 (“power plant system 350”) can be “modular” in that each of the nuclear reactors 300 can be operated separately to provide an output, such as electricity or steam. The power plant system 350 can include fewer than twelve of the nuclear reactors 300 (e.g., two, three, four, five, six, seven, eight, nine, ten, or eleven of the nuclear reactors 300), or more than twelve of the nuclear reactors 300. The power plant system 350 can be a permanent installation or can be mobile (e.g., mounted on a truck, tractor, mobile platform, and/or the like). In the illustrated embodiment, each of the nuclear reactors 300 can be positioned within a common housing 351, such as a reactor plant building, and controlled and/or monitored via a control room 352.

Each of the nuclear reactors 300 can be coupled to a corresponding electrical power conversion system 340 (individually identified as first through twelfth electrical power conversion systems 340a-l, respectively). The electrical power conversion systems 340 can include one or more devices that generate electrical power or some other form of usable power from steam generated by the nuclear reactors 300. In some embodiments, multiple ones of the nuclear reactors 300 can be coupled to the same one of the electrical power conversion systems 340 and/or one or more of the nuclear reactors 300 can be coupled to multiple ones of the electrical power conversion systems 340 such that there is not a one-to-one correspondence between the nuclear reactors 300 and the electrical power conversion systems 340.

The electrical power conversion systems 340 can be further coupled to an electrical power transmission system 354 via, for example, an electrical power bus 353. The electrical power transmission system 354 and/or the electrical power bus 353 can include one or more transmission lines, transformers, and/or the like for regulating the current, voltage, and/or other characteristic(s) of the electricity generated by the electrical power conversion systems 340. The electrical power transmission system 454 can route electricity via a plurality of electrical output paths 355 (individually identified as electrical output paths 355a-n) to one or more end users and/or end uses, such as different electrical loads of an integrated energy system.

Each of the nuclear reactors 300 can further be coupled to a steam transmission system 356 via, for example, a steam bus 357. The steam bus 357 can route steam generated from the nuclear reactors 300 to the steam transmission system 356 which in turn can route the steam via a plurality of steam output paths 358 (individually identified as steam output paths 358a-n) to one or more end users and/or end uses, such as different steam inputs of an integrated energy system.

In some embodiments, the nuclear reactors 300 can be individually controlled (e.g., via the control room 352) to provide steam to the steam transmission system 356 and/or steam to the corresponding one of the electrical power conversion systems 340 to provide electricity to the electrical power transmission system 354. In some embodiments, the nuclear reactors 300 are configured to provide steam either to the steam bus 357 or to the corresponding one of the electrical power conversion systems 340 and can be rapidly and efficiently switched between providing steam to either. Accordingly, in some aspects of the present technology the nuclear reactors 300 can be modularly and flexibly controlled such that the power plant system 350 can provide differing levels/amounts of electricity via the electrical power transmission system 354 and/or steam via the steam transmission system 356. For example, where the power plant system 350 is used to provide electricity and steam to one or more industrial process-such as various components of the integrated energy systems, the nuclear reactors 300 can be controlled to meet the differing electricity and steam requirements of the industrial processes.

As one example, during a first operational state of an integrated energy system employing the power plant system 350, a first subset of the nuclear reactors 300 (e.g., the first through sixth nuclear reactors 300a-f) can be configured to provide steam to the steam transmission system 356 for use in the first operational state of the integrated energy system, while a second subset of the nuclear reactors 300 (e.g., the seventh through twelfth nuclear reactors 300g-1) can be configured to provide steam to the corresponding ones of the electrical power conversion systems 340 (e.g., the seventh through twelfth electrical power conversion systems 340g-1) to generate electricity for the first operational state of the integrated energy system. Then, during a second operational state of the integrated energy system when a different (e.g., greater or lesser) amount of steam and/or electricity is required, some or all the first subset of the nuclear reactors 300 can be switched to provide steam to the corresponding ones of the electrical power conversion systems 340 (e.g., the seventh through twelfth electrical power conversion systems 340g-1) and/or some or all of the second subset of the nuclear reactors 300 can be switched to provide steam to the steam transmission system 356 to vary the amount of steam and electricity produced to match the requirements/demands of the second operational state. Other variations of steam and electricity generation are possible based on the needs of the integrated energy system. That is, the nuclear reactors 300 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 300 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

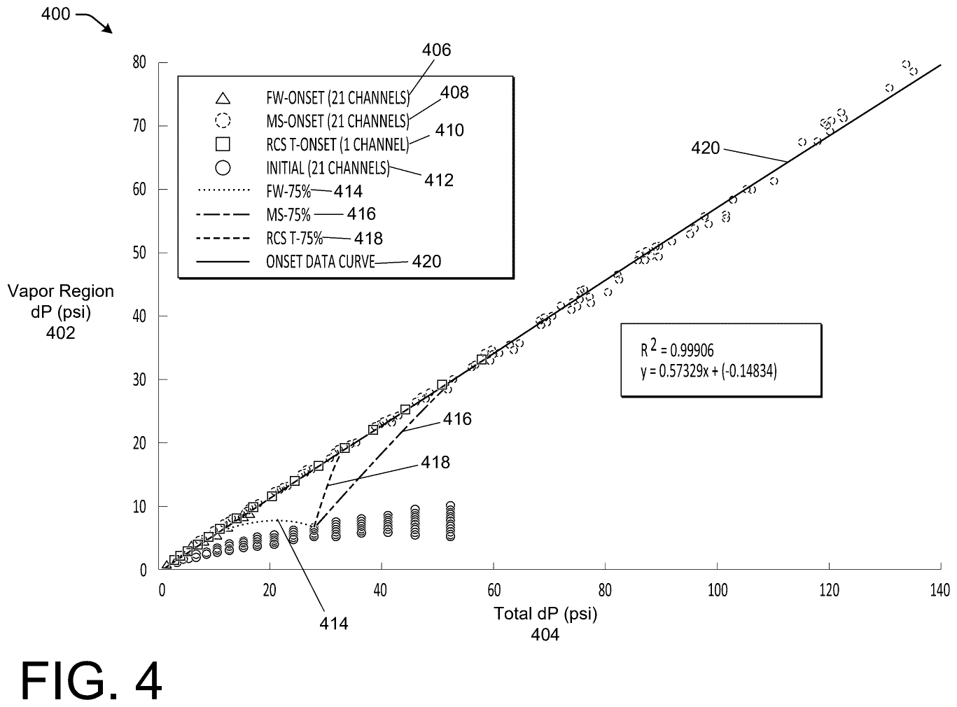

FIG. 4 is a graph 400 illustrating Steam Generator (SG) tube vapor phase region pressure drop 402 compared to total SG tube pressure drop 404. In an embodiment, the graph 400 includes a plurality of plot points for feedwater (FW) onset 406, main steam (MS) onset 408, reactor coolant system (RCS) temperature onset 410, and initial conditions 412. In an embodiment, the graph 400 includes a curve depicting FW at 75% 414, a curve depicting MS at 75% 416, a curve depicting RCS temperature at 75% 418, and an onset data curve 420.

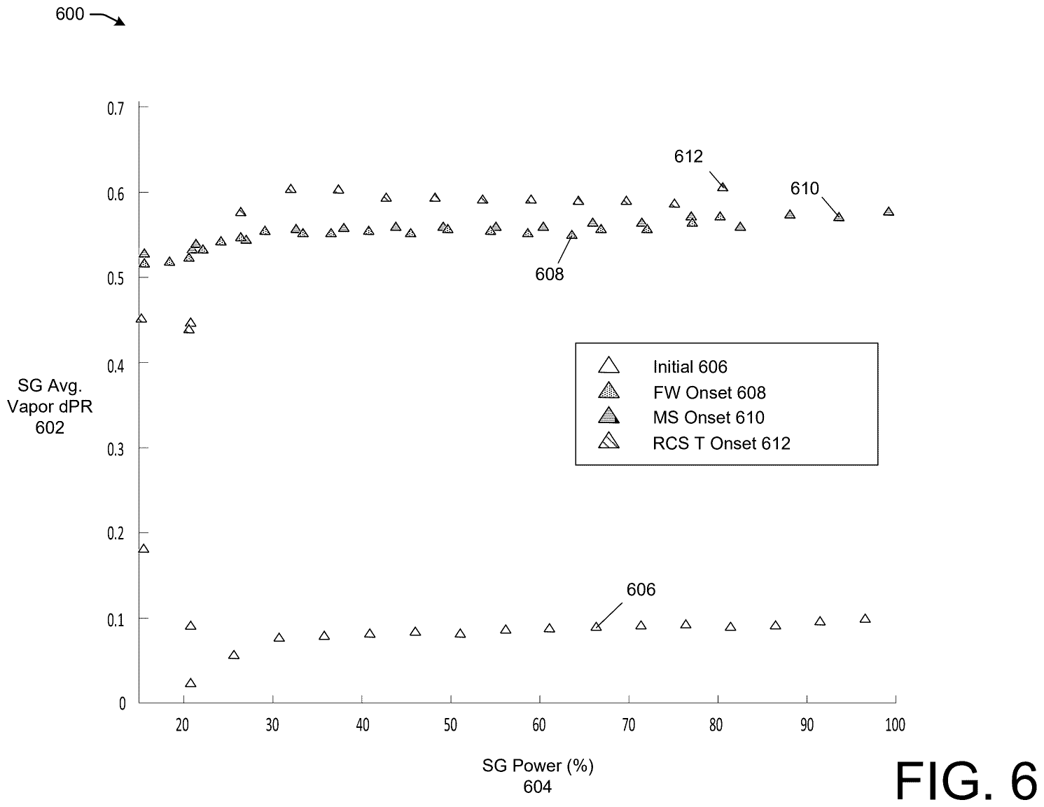

Graph 400 is consistent with two phase stability theory when considering the vapor region pressure drop (See in more detail in FIG. 6) as a lumped two-phase region exit pressure drop where increasing exit pressure drop is destabilizing. In other words, the NPM SG vapor length loosely correlates to the boiling water reactor (BWR) assembly upper tie plate where increasing the vapor length is analogous to a more restrictive upper tie plate.

In an embodiment, with the increased exit flow resistance, any boiling variations within the boiling region of the SG tube will result in tube pressure variations that manifest as tube inlet flow variations. The variations to inlet flow then produce a change in the boiling rate causing a change in the tube exit pressure. This inlet/outlet flow feedback loop is the driving mechanism for either a dampened oscillation (i.e., stable flow) or the development of oscillation growth to a characteristic limit cycle (i.e., unstable flow). This is a unique characteristic of multiple parallel boiling channel configurations where the inlet and outlet boundary pressures are uninfluenced by the flow behavior in a given channel.

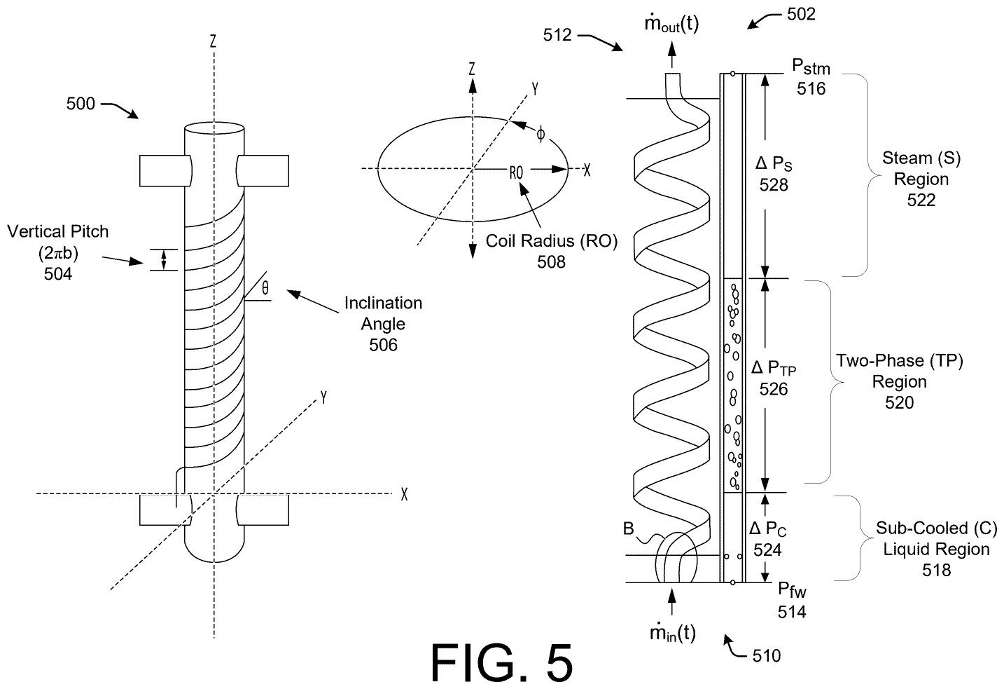

FIG. 5 illustrates a diagram of a helically coiled SG 500 with respect to an X, a Y, and a Z-axis and a helically coiled SG tube 502. In an embodiment, the SG 500 may include a plurality of SG tubes 502. In an embodiment, the SG 500 may be helically coiled with a vertical pitch 504, an inclination angle 506, and may have a coil radius 508. In an embodiment, the SG tube 502 may include an inlet end 510 and an outlet end 512. In an embodiment, liquid may flow through the inlet end 510 at a pressure 514 (e.g., P_{fw}) having a mass flowrate (e.g., \dot{m}ᵢₙ(t)). In an embodiment, steam may flow through the outlet end 512 at a pressure 516 (e.g., Pₛₜₘ) having a mass flowrate (e.g., \dot{m}ₒᵤₜ(t)).

In an embodiment, the SG tube 502 may include a sub-cooled liquid region 518 (e.g., liquid region, first region, etc.), a two-phase region 520 (e.g., wet-vapor region, second region, etc.), and a steam region 522 (e.g., vapor region, third region, etc.). In an embodiment, there may be a differential pressure of the subcooled liquid 524 (e.g., ΔP_{C}) within the sub-cooled liquid region 518. In an embodiment, the liquid region 518 may be adjacent to the inlet end 510. In an embodiment, the liquid region 518 may be adjacent to the two-phase region 520. In an embodiment, the two-phase region 520 may be adjacent to the steam region 522. In an embodiment, the steam region 522 may be adjacent to the outlet end 512.

The ΔP_{C} 524 may represent the difference between the pressure of the liquid entering the sub-cooled liquid region 518 than exiting the sub-cooled liquid region 518. In an embodiment, there may be a differential pressure of the two-phase fluid 526 (e.g., ΔP_{TP}) within the two-phase region 520. The ΔP_{TP} 526 may represent the difference between the pressure of the two-phase fluid entering the two-phase region 520 than exiting the two-phase region 520. In an embodiment, there may be a differential pressure of the steam 528 (e.g., ΔP_{S}) within the steam region 522. The ΔP_{S} 528 may represent the difference between the pressure of the steam entering the steam region 522 than exiting (e.g., discharging from) the steam region 522.

FIG. 6 is a graph 600 illustrating the ratio of vapor pressure drop and SG tube pressure drop 602 (e.g., SG Avg. Vapor dPR) as a function of tube flow 604 (e.g., SG Power (%)). In an embodiment graph 600 may include nominal operating initial vapor pressure drop fractions 606, feedwater (FW) onset vapor pressure drop fractions 608 (e.g., FW Onset), main steam (MS) onset vapor pressure drop fractions 610 (e.g., MS Onset), and reactor coolant system (RCS) temperature onset vapor pressure drop fractions 612 (e.g., RCS T Onset).

In an embodiment, normalizing the vapor pressure drop fraction as a function of SG tube flow may reveal a simple stability map where specific operating pressure drop fractions can be compared to the onset vapor pressure drop fraction.

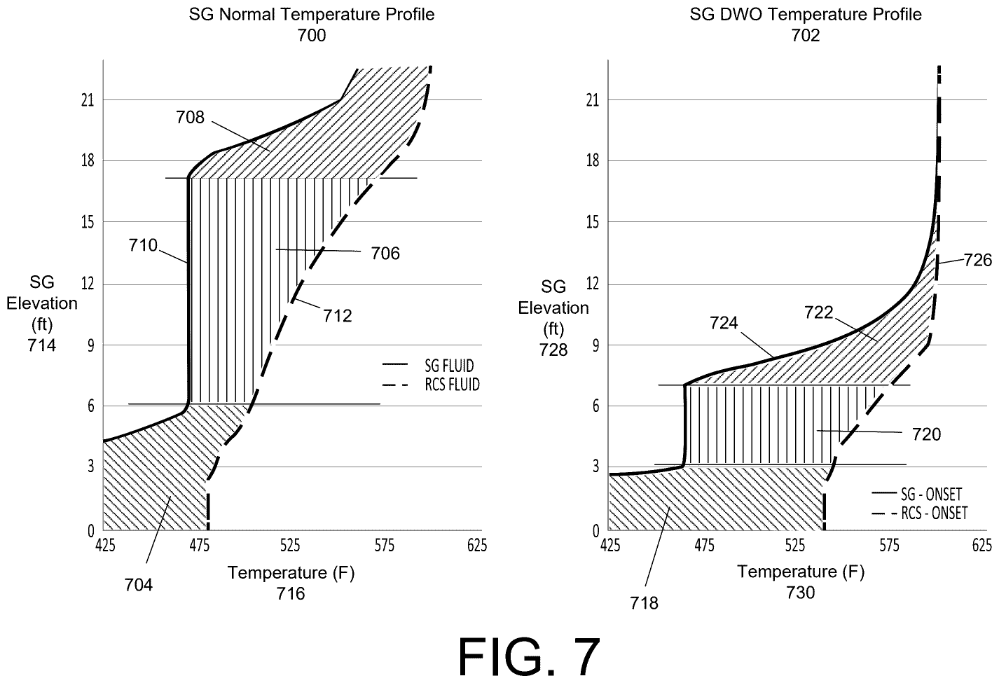

FIG. 7 is a graph illustrating an SG normal temperature profile 700 (“normal profile”) and an SG DWO temperature profile 702 (“DWO profile”). In an embodiment, the normal profile 700 may illustrate a subcooled liquid region 704 (e.g., liquid region, liquid fluid region, etc.), a two-phase region 706 (e.g., wet-vapor region, mixed-vapor region, etc.), and a superheated vapor region 708 (e.g., steam region, etc.) between a SG fluid curve 710 and a RCS fluid curve 712 relative to the SG elevation (ft) 714 and temperature (F) 716.

In an embodiment, the DWO profile 702 may illustrate a subcooled liquid region 718 (e.g., liquid region, liquid fluid region, etc.), a two-phase region 720 (e.g., wet-vapor region, mixed-vapor region, etc.), and a superheated vapor region 722 (e.g., steam region, etc.) between a SG onset curve 724 and a RCS onset curve 726 relative to the SG elevation (ft) 728 and temperature (F) 730.

In an embodiment, it may not be possible to directly measure vapor region pressure drop or even the vapor region length in the SG tubes (not shown in FIG. 7, see FIG. 5). However, the vapor length within the SG tube may be directly inferred from the steam outlet temperature. Due to the principles of in-tube convective heat transfer, the temperature profile may be simplified to an exponential function of heat transfer length. This is demonstrated by the normal profile 700 and the DWO profile 702.

In an embodiment, the lengths of the liquid region 718 and two-phase region 720, as determined using the DWO profile 702, may be much shorter than the lengths of the liquid region 704 and two-phase region 706, as determined using the normal profile 700. In an embodiment, the vapor lengths of the two-phase region 720 and the steam region 722, as determined using the DWO profile 702, may be dramatically increased compared to the vapor lengths of the two-phase region 706 and the steam region 708, as determined using the normal profile 700.

In an embodiment, the difference between the SG onset curve 724 and the RCS onset curve 726 at the 21 ft elevation (i.e., SG fluid exit temperature) collapses to nearly zero difference in the DWO profile 702. In an embodiment, the temperature of the steam region 708 of the normal profile 700 and the steam region 722 of the DWO profile 702, may be considered as a constant, which may simplify the relationship between the SG outlet approach temperature (i.e., the temperature difference between the SG fluid exit temperature and the RCS temperature) and the vapor length.

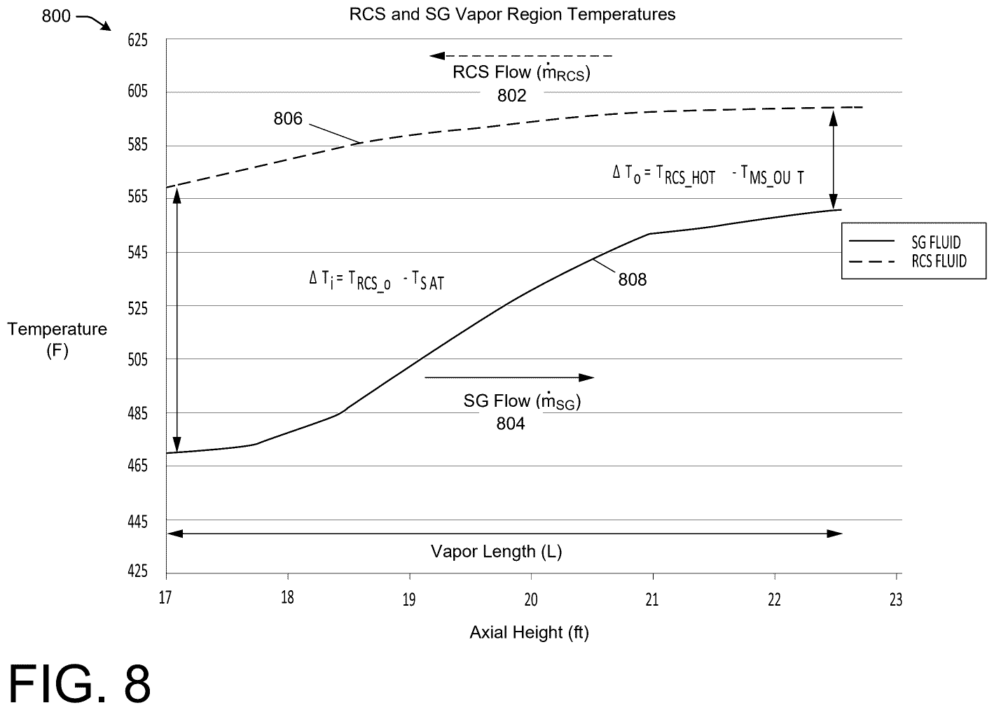

FIG. 8 is a graph 800 illustrating SG tube vapor region temperature profiles for Reactor Coolant System (RCS) flow 802 and SG flow 804.

In an embodiment, the relationship between the SG approach temperature and vapor length may be derived using the combination of the primary and secondary side fluid energy balances and Newton's law of cooling. In an embodiment, the control volume of interest contains single-phase vapor on the secondary side and single-phase liquid on the primary side (i.e., steam within the SG tubes and superheated liquid surrounding the SG tubes). Heat is transferred from the primary side to the secondary side through the SG tube wall. This derivation is demonstrated by the RCS temperature profile 806, the SG temperature profile 808 and flow directions.

Using a simple fluid energy balance, the enthalpy change of each side can be obtained using the RCS mass flowrate 802 heat capacity and the SG mass flowrate 804 heat capacity in equations (1) and (2) below. The differential forms of equation (1) and (2) are shown respectively in equations (3) and (4) below for the RCS and SG sides.

$${Q}_{R C S} = {\dot{m}}_{R C S} {C}_{{p}_{-} R C S} ( {T}_{R C {S}_{0}} - {T}_{R C {S}_{h o t}} ) \qquad ( 1 )$$

$${Q}_{S G} = {\dot{m}}_{S G} {C}_{{p}_{-} S G} ( {T}_{M {S}_{o u t}} - {T}_{Sat} ) \qquad ( 2 )$$

$$d {q}_{R C S} = {\dot{m}}_{R C S} {C}_{{p}_{-} R C S} d {T}_{R C S} \qquad ( 3 )$$

$$d {q}_{S G} = {\dot{m}}_{S G} {C}_{{p}_{-} S G} d {T}_{S G} \qquad ( 4 )$$

The overall primary to secondary side energy balance yields:

$$- d {q}_{R C S} = d {q}_{S G} \qquad ( 5 )$$

The convective heat transfer relationship is given by equation (6) and the differential form of the convective temperature difference is defined by equation (7).

$$d q = U Δ T d A = U Δ T π Ddx \qquad ( 6 )$$

$$d ( Δ T ) = d {T}_{R C S} - d {T}_{S G} \qquad ( 7 )$$

Substituting equations (3), (4) and (5) into equation (7) yields equation (8).

$$d ( Δ T ) = - d q ( \frac{1}{{\dot{m}}_{S G} {C}_{{p}_{-} S G}} + \frac{1}{{\dot{m}}_{R C S} {C}_{{p}_{-} R C S}} ) \qquad ( 8 )$$

Substituting equation (6) into equation (8) and dividing both sides by ΔT yields equation (9)

$$\frac{d Δ T}{Δ T} = - U π D ( \frac{1}{{\dot{m}}_{S G} {C}_{{p}_{-} S G}} + \frac{1}{{\dot{m}}_{R C S} {C}_{{p}_{-} R C S}} ) d x \qquad ( 9 )$$

Integrating left side of equation (9) over the inlet to outlet temperature change and the right side over the vapor length as shown in equation (10), yields the solution given by equation (11).

$${\int }_{Δ {T}_{i}}^{Δ {T}_{o}} \frac{d Δ T}{Δ T} = - U π D ( \frac{1}{{\dot{m}}_{S G} {C}_{{p}_{-} S G}} + \frac{1}{{\dot{m}}_{R C S} {C}_{{p}_{-} R C S}} ) {\int }_{0}^{L} dx \qquad ( 10 )$$

$$ln ( \frac{Δ {T}_{o}}{Δ {T}_{i}} ) = - U π DL ( \frac{1}{{\dot{m}}_{S G} {C}_{{p}_{-} S G}} + \frac{1}{{\dot{m}}_{R C S} {C}_{{p}_{-} R C S}} ) \qquad ( 11 )$$

Equation (11) can be rearranged by replacing the fluid heat capacities dT/q from equations (3) and (4) to develop the traditional form of the log mean temperature difference heat transfer relationship (not shown). However, the flow enthalpy of the primary side of the SG tube may be approximately ten times larger than that of the secondary vapor region and RCS temperature drop may be relatively small compared to the vapor region temperature rise, such that equation (12) is valid.

$$\frac{1}{{\dot{m}}_{S G} {C}_{{p}_{-} S G}} ≫ \frac{1}{{\dot{m}}_{R C S} {C}_{{p}_{RCS}}} and {T}_{{RCS}_{o}} ≅ {T}_{R C {S}_{h o t}} \qquad ( 12 )$$

The order of magnitude approximation simplifies equation (11) such that the approach temperature is an exponential function of the vapor length and secondary flowrate as shown in equation (13). Solving for the vapor length yields equation (14). These results demonstrate the exponential relationship between approach temperature and vapor pressure drop ratio through the physical characteristic of vapor length.

$$Δ {T}_{a p p} = ( {T}_{R C {S}_{h o t}} - {T}_{S {G}_{s a t}} ) exp ( \frac{- U π D L}{{\dot{m}}_{S G} {C}_{{p}_{-} S G}} ) \qquad ( 13 )$$

$${L}_{vapor} = ( \frac{{\dot{m}}_{SG} {C}_{p\_SG}}{- U π D} ) ln ( \frac{Δ {T}_{a p p r o a c h}}{{T}_{R C {S}_{h o t}} - {T}_{{SG}_{s a t}}} ) \qquad ( 14 )$$

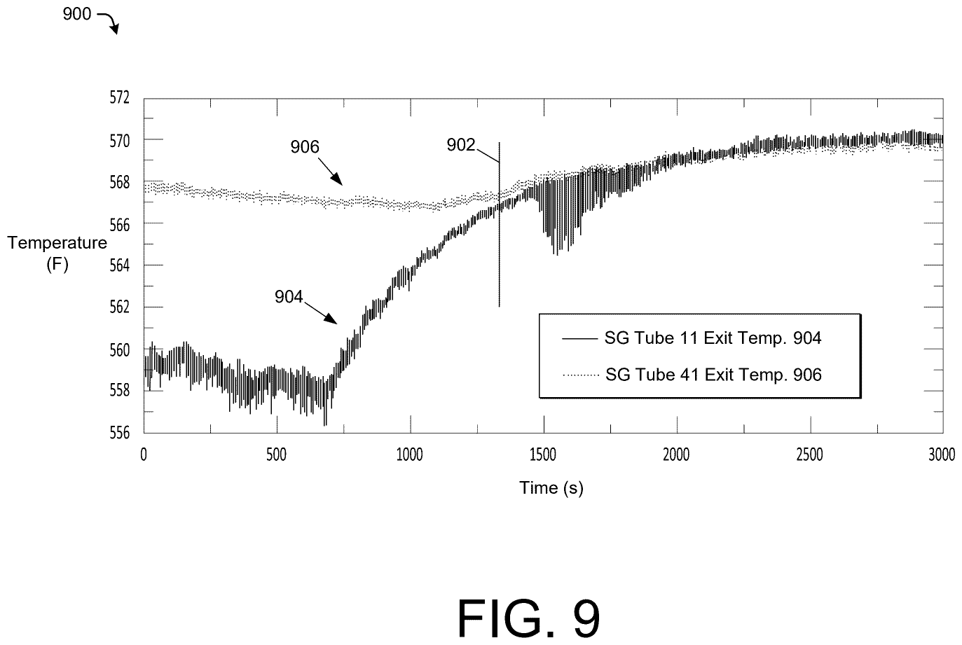

FIG. 9 is a graph 900 illustrating approach temperature during a DWO flow ramp test. In an embodiment, the relationship between approach temperature and DWO onset is confirmed in the SIET TF-2 test reactor, which has direct measurement of certain SG tube inlet flowrates and in-tube fluid temperatures. The SIET TF-2 test reactor allows for direct analysis of the SG tube steam temperature before, during, and after a DWO event. Specifically, SG tubes 11 and 41 of row 3 within the SIET TF-2 test reactor have both temperature and flow instrumentation. SG tube 11 fluid exit temperature 904, as measured by TF-2315, and SG tube 41 fluid exit temperature 906, as measured by TF-2325, were measured about 2 meters before the exits for SG tube 11 and SG tube 41, respectively.

Graph 900, developed from the TF-2 assessment calculation, provides an example of the tube steam to primary temperature difference during the FW ramp for test S03-66-927. The temperature difference reduces logarithmically as DWO onset 902 occurs indicated by the vertical line. Similar behavior across the test series may be observable where a measurable temperature difference between the RCS and in-tube temperatures corresponds to tube stability, while loss of the approach temperature corresponds to DWO onset.

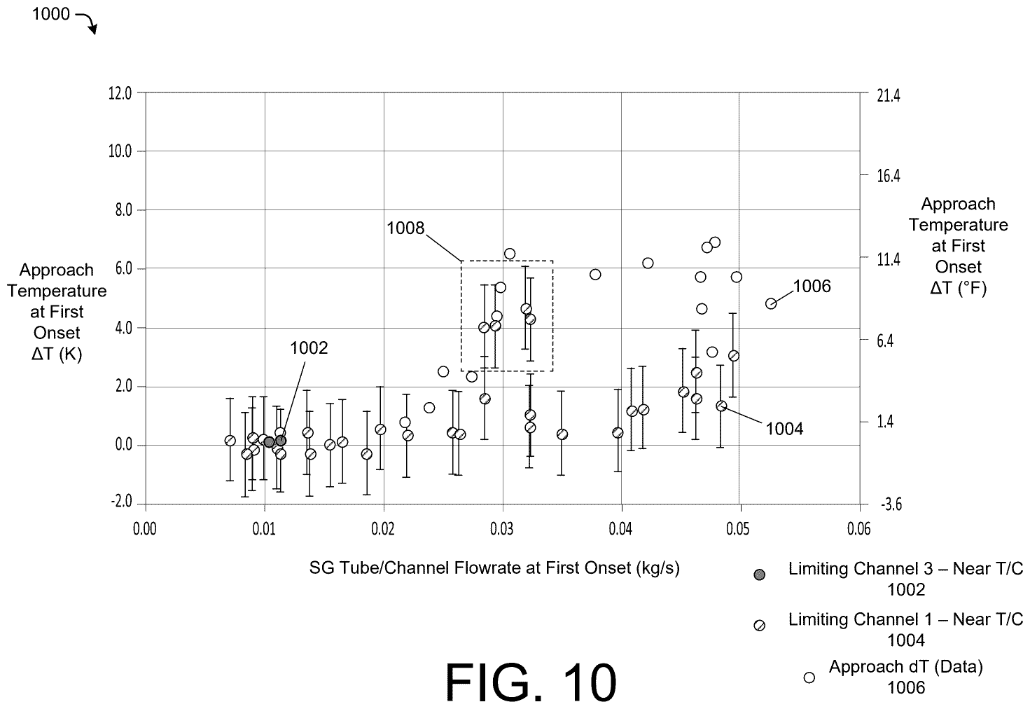

FIG. 10 is a graph 1000 illustrating a code to data comparison for approach temperature. A thermal-hydraulic analysis assessment conducted the code to data comparison using the first SG tube to enter DWO. This methodology reduces the number of DWO onset data points to the subset of tests where one of the temperature instrumented SG tubes was the first to observe onset of DWO. The results of this data subset include the limiting channel 3 plot points 1002, the limiting channel 1 plot points 1004, and the approach dT 1006. Based at least in part on the limiting channel 3 plot points 1002, the limiting channel 1 plot points 1004, and the approach dT 1006, the following conclusions are made from the assessment results:
1. The approach temperature at onset increases with power, as indicated by the SG tube flowrate; and
2. The thermal-hydraulic analysis assessment model tends to over predict the approach temperature at onset.

In the evaluation of the assessment results, four outlier data points are identified in the region 1008. In an embodiment, the outlier data points within the region 1008 all have fairly noisy initial flow signals and slow developing limit cycle onset conditions which adds variability to the period based “first onset” signal processing algorithm, which is magnified by the fact that the outlier data points within the region 1008 also have rapid decreasing approach temperature at the time of DWO onset creating the uniquely high “reported” DWO onset approach temperature. In an embodiment, more detailed manual evaluation of the data may confirm that by manually processing these test cases, a more representative approach temperature may be developed closer to the trend for the balance of the data.

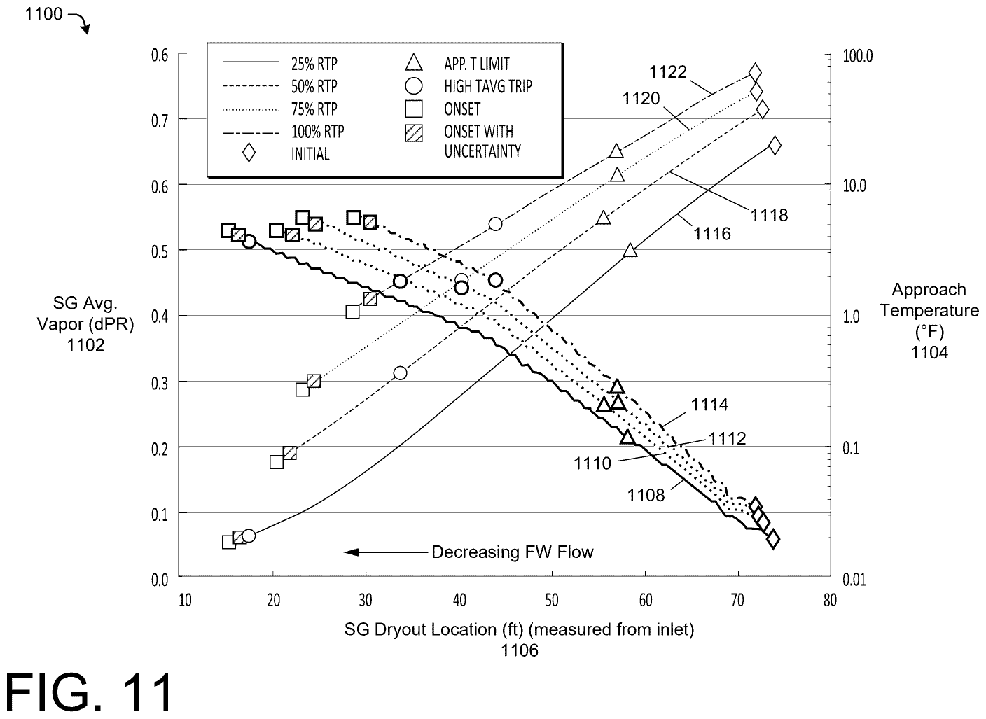

FIG. 11 is a graph 1100 illustrating flowrate decrease results for SG average vapor differential pressure (dPR) 1102 and approach temperature 1104 compared to SG dryout location 1106.

In an embodiment, the graph 1100 may include a 25% rated thermal power (RTP) curve 1108, a 50% RTP curve 1110, a 75% RTP curve 1112, and a 100% RTP curve 1114 related to the SG avg. vapor differential pressure dPR 1102 and the SG dryout location 1106.

In an embodiment, the graph 1100 may include a 25% rated thermal power (RTP) curve 1116, a 50% RTP curve 1118, a 75% RTP curve 1120, and a 100% RTP curve 1122 related to the approach temperature 1104 and the SG dryout location 1106.

Graph 1100 presents results for feedwater flowrate onset ramp calculations performed as part of an approach temperature limit analysis. In an embodiment, flow is slowly decreased at a rate of 0.5% of the initial value over 100 seconds. System boundary conditions for primary and secondary pressure, primary hot and secondary inlet temperature, and primary flow are held constant. The SG average vapor differential pressure (dPR) 1102 and approach temperature 1104 may be plotted versus the SG dryout location 1106 from the initial condition (diamond) to the point of onset (square). As the dryout elevation decreases, the overall vapor dPR ratio increases and approach temperature decreases as the longer vapor length allows additional heating of the vapor region.

In graph 1100, conditions at the point where approach temperature passes through the limit line are shown as triangles. Graph 1100 demonstrates that there is a significant margin, in terms of SG level, between the onset point marked by the approach temperature limit line (triangle) versus calculated onset (square).

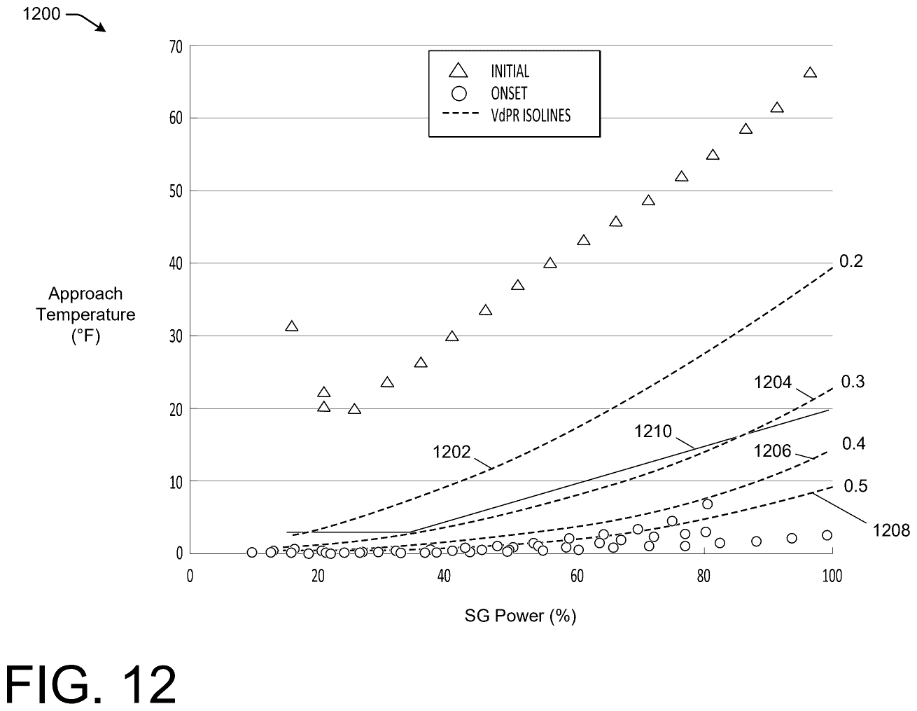

FIG. 12 is a graph 1200 illustrating approach temperature at DWO onset as a function of SG power. In an embodiment, graph 1200 may include a vapor dPR (VdPR) isoline 1202 (e.g., first VdPR line, etc.), vapor dPR (VdPR) isoline 1204 (e.g., second VdPR line, etc.), vapor dPR (VdPR) isoline 1206 (e.g., third VdPR line, etc.), and vapor dPR (VdPR) isoline 1208 (e.g., fourth VdPR line, etc.), and a DWO limit line 1210. In an embodiment, the first VdPR line 1202 may be the graphical representation for a VdPR of 0.2. In an embodiment, the second VdPR line 1204 may be the graphical representation for a VdPR of 0.3. In an embodiment, the third VdPR line 1206 may be the graphical representation for a VdPR of 0.4. In an embodiment, the fourth VdPR line 1206 may be the graphical representation for a VdPR of 0.5.

The graph 1200 presents case spectrum results for RCS temperature, MS pressure, and FW flow ramp types, with approach temperature at the initial operating conditions (triangle) and the calculated point of DWO onset (circle). Data represents approach temperature at the time of earliest onset in any evaluated SG column. Vapor dPR isolines (e.g., the first VdPR line 1202, the second VdPR line 1204, the third VdPR line 1206, and the fourth VdPR line 1298) are generated using average SG vapor dPR results during each ramp case.

The following observations and conclusions are drawn based on results presented above:
1. Significant SG level decrease, approximately 60%, is required to move from normal SG operating conditions to the calculated point of DWO onset. This level change is consistently represented as a change in SG outlet approach temperature;
2. The calculated point of DWO onset occurs at a minimum SG average vapor dPR of approximately 0.5. The approach temperature limit line corresponds to approximately 0.3 vapor dPR. The nominal operating point is approximately 0.1 vapor dPR meaning the limit line represents 50% margin to onset; and
3. The NPM reactor safety trip signals for high RCS average temperature and Low MS pressure ensure DWO onset protection for high power operations (above 50%).

These observations and conclusions confirm that the specified approach temperature limit line provides a high degree of margin to actual DWO onset in terms of vapor dPR and SG level and that the DWO limit line 1210 denotes an operating space above which DWO is precluded.

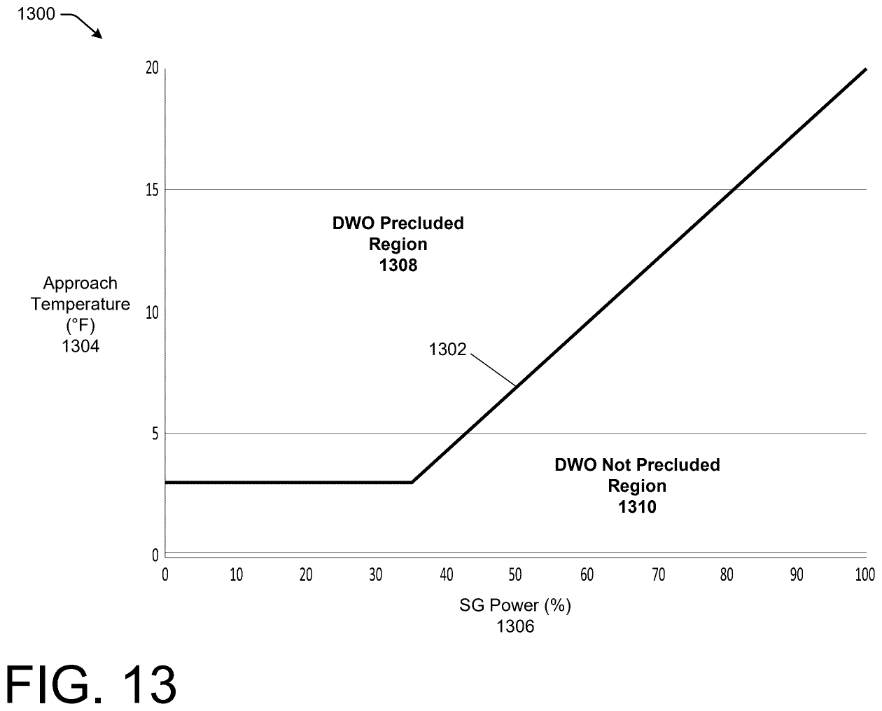

FIG. 13 is a graph 1300 illustrating a DWO limit line 1302, relative to DWO events, as a function of approach temperature 1304 and SG power 1306. In an embodiment, the graph 1300 may include a DWO precluded region 1308 and a DWO not precluded region 1310. In an embodiment, when system conditions are within the DWO precluded region 1308, it may be less likely that a DWO event will occur. In an embodiment, when system conditions are within the DWO not precluded region 1310, it may be more likely that a DWO event will occur.

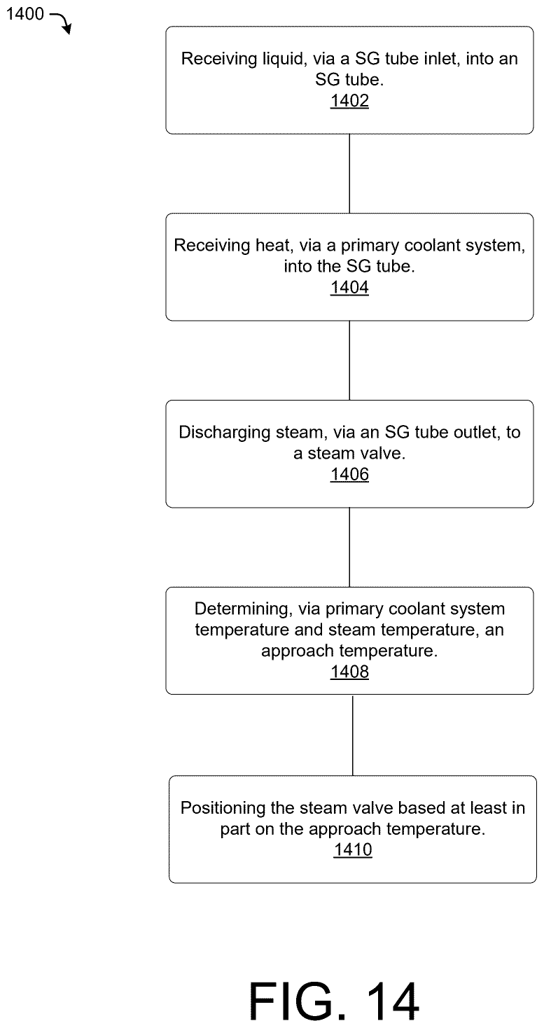

FIG. 14 illustrates an example process 1400 to control flow within a SG tube, according to an embodiment of this disclosure. The order in which the operations or steps are described is not intended to be construed as a limitation, and any number of the described operations may be combined in any order and/or in parallel, as required.

At step 1402, the process 1400 may include receiving liquid, via a SG tube inlet, into an SG tube. For example, an SG tube may include an inlet portion that is fluidly connected to a liquid source (e.g., feedwater system, condensate system, etc.) and configured to receive liquid from the liquid source.

At step 1404, the process 1400 may include receiving heat, via a primary coolant system, into the SG tube. For example, the SG tube may be surrounded by primary coolant. The primary coolant may have consistent contact with an outer surface of the SG tube. While the primary coolant is in contact with the outside surface of the SG tube, heat from the primary coolant may be absorbed by the relatively cooler SG tube wall, which may then be transferred into the fluid within the SG tube.

At step 1406, the process 1400 may include discharging steam, via an SG tube outlet, to a steam valve. For example, the SG tube may include an outlet portion that is fluidly connected with a steam valve. In an embodiment, the liquid with the SG tube may receive enough heat from the primary coolant contacting that SG tube wall to be converted into steam. As the fluid continues to flow through the SG tube, the steam adjacent to the outlet portion of the SG tube will be discharged out of the SG tube toward the steam valve.

At step 1408, the process 1400 may include determining, via primary coolant system temperature and steam temperature, an approach temperature. For example, the approach temperature for a SG may be determined by comparing the temperature difference between the peak primary coolant temperature and the temperature of the steam discharged from the SG tube.

In an embodiment, a small temperature difference between the peak primary coolant temperature and the temperature of the steam discharged from the SG tube indicates a large volume, or level, of steam within the SG tube because steam would have more opportunity to absorb heat from the primary coolant in contact with the SG tube wall.

In an embodiment, a large temperature difference between the peak primary coolant temperature and the temperature of the steam discharged from the SG tube indicates a relatively small volume, or level, of steam within the SG tube because steam would have less opportunity to absorb heat from the primary coolant in contact with the SG tube wall.

At step 1410, the process 1400 may include positioning the steam valve based at least in part on the approach temperature. For example, in order to increase the approach temperature, the steam valve may be partially closed. By partially closing the steam valve, less steam may exit the SG tube, thereby increasing the pressure within the SG tube. The increased pressure within the tube will raise the temperature required for the liquid within the SG tube to be converted into steam, thus increasing the volume, or level, of liquid within the SG tube. Because the length of the total volume of the SG tube does not change, the steam volume within the SG tube must decrease as the liquid volume increases, thus reducing the temperature of the steam discharged from the SG tube. The reduced temperature of the steam discharged from the SG tube increases the differential pressure of the peak primary coolant temperature and the temperature of the steam discharged from the SG tube, which increases the approach temperature. When approach temperature increases, the probability of a DWO event decreases.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated and may include indirect connections through one or more intermediary elements. Likewise, the terms “directly” and “indirectly” describe both physical contact between components and connections made through intermediate structures, mechanisms, or devices.

What is claimed is:

1. A flow control system comprising:
a steam generator (SG) having an inlet and an outlet, the SG including a plurality of SG tubes extending from the inlet to the outlet;
a primary coolant system configured to transfer heat to the SG;
a steam valve fluidly connected to the outlet of the SG; and
an SG level control system configured to operate the steam valve based at least in part on an approach temperature.

2. The flow control system according to claim 1, wherein the approach temperature includes SG outlet temperature and primary coolant system temperature.

3. The flow control system according to claim 1, wherein the plurality of SG tubes is helically coiled.

4. The flow control system according to claim 1, wherein the steam valve is at least one of:
a solenoid valve;
a pneumatic valve; and
a manually operated valve.

5. The flow control system according to claim 1, wherein the plurality of SG tubes includes:
a liquid region adjacent to the inlet of the SG;
a two-phase region extending from the liquid region; and
a steam region extending from the two-phase region to the outlet of the SG.

6. The flow control system according to claim 1, wherein the approach temperature increases as the steam valve is shut.

7. A method for flow control comprising:
receiving liquid, via a SG tube inlet, into an SG tube;
receiving heat, via a primary coolant system, into the SG tube;
discharging steam, via an SG tube outlet, to a steam valve;
determining, via primary coolant system temperature and steam temperature, an approach temperature; and
positioning the steam valve based at least in part on the approach temperature.

8. The method according to claim 7, further comprising determining a steam level within the SG tube based at least in part on the approach temperature.

9. The method according to claim 8, further comprising determining a liquid level within the SG tube based at least in part on the approach temperature.

10. The method according to claim 7, further comprising shutting the steam valve based at least in part on a decrease of the approach temperature.

11. The method according to claim 7, further comprising opening the steam valve based at least in part on an increase of the approach temperature.

12. The method according to claim 7, further comprising increasing, via the steam valve, liquid flow into the SG tube inlet.

13. The method according to claim 7, further comprising decreasing, via the steam valve, liquid flow into the SG tube inlet.

14. A flow control system comprising:
one or more processors; and
one or more computer-readable media storing instructions executable by the one or more processors, wherein the instructions, when executed by the one or more processors, cause the one or more processors to perform operations comprising:
receiving liquid, via a SG tube inlet, into a SG tube;
receiving heat, via a primary coolant system, into the SG tube;
discharging steam, via an SG tube outlet, to a steam valve;
determining, via primary coolant system temperature and steam temperature, an approach temperature; and
positioning the steam valve based at least in part on the approach temperature.

15. The flow control system of claim 14, further comprising determining a steam level within the SG tube based at least in part on the approach temperature.

16. The flow control system of claim 15, further comprising determining a liquid level within the SG tube based at least in part on the approach temperature.

17. The flow control system of claim 14, further comprising shutting the steam valve based at least in part on a decrease of the approach temperature.

18. The flow control system of claim 14, further comprising opening the steam valve based at least in part on an increase of the approach temperature.

19. The flow control system of claim 14, further comprising increasing, via the steam valve, liquid flow into the SG tube inlet.

20. The flow control system of claim 14, further comprising decreasing, via the steam valve, liquid flow into the SG tube inlet.
